(19) United States
(12) Patent Application Publication
(10) Pub. No.: US 2018/0314815 A1
(43) Pub. Date: Nov. 1, 2018

(54) HAND-HELD ELECTRONIC DEVICE WITH LOCKING INTERFACE

(71) Applicant: Roland K. Bowler, II, Kildeer, IL (US)

(72) Inventor: Roland K. Bowler, II, Kildeer, IL (US)

(21) Appl. No.: 15/582,756

(22) Filed: Apr. 30, 2017

(51) Int. Cl. G06F 21/36; G06F 3/0488; H04M 1/725

(52) U.S. Cl. CPC G06F 21/36; H04M 1/72544; G06F 3/0488

(57) ABSTRACT

A portable hand held communication device having an electrical circuit coupled to a visual display interface and to a user input interface is disclosed. The electrical circuit is configured to display a foreground image, different than a home screen image, on the visual display interface in response to a first input at the user input interface when the device is unlocked, lock the device, and continue to display the foreground image after the device is locked, wherein the locked device is substantially unresponsive to input at the user input interface when the foreground image is displayed.

### FIELD OF THE DISCLOSURE

The present disclosure relates generally to portable electronic devices with visual display interfaces, and more particularly to user interface locking features for such devices, for example, mobile phones and other portable electronic devices, and methods therefor.

### BACKGROUND

Hand-held cell phones, laptop computers, tablets and other portable electronic devices are now capable of storing, managing and providing access to unprecedented amounts of information. Some such information may be stored locally on the device and other information may be stored remotely on a server where it is accessed from the device via a wired or wireless interface. It's known generally to condition access to a portable electronic device on successful authentication of the party requesting access. Cellphones for example may be configured to require users to input authentication information at a user interface before granting access to the device. Authentication information may be in the form of tactile information (e.g., personal passcode or swipe pattern) or a biometric identifier (e.g., fingerprint, retinal, iris or voice) among other information input at the user interface to gain device access.

Generally, a locked device is inaccessible or substantially inaccessible to a user. However an authentication interface of a locked device may accept a limited number of authentication attempts. Moreover some devices may provide limited access to specific functionality other than authentication when the device is locked. For example, wireless communication devices in some countries permit the making of emergency (e.g., 911) calls from the device while the device is otherwise locked.

Advances in encryption and authentication have made commonplace the use of portable electronic devices as repositories of increasingly private or sensitive information or as gateways to remote repositories of such information. These advances have also enabled the use of portable electronic devices for secure communications like on-line banking and other transactions where personal or confidential information is conveyed privacy and security are paramount. Despite these advances, portable electronic devices remain susceptible to privacy invasion.

The various aspects, features and advantages of the present disclosure will become more fully apparent to those having ordinary skill in the art upon careful consideration of the following Detailed Description and the accompanying drawings described below.

### BRIEF DESCRIPTION OF THE DRAWINGS

FIG. 1 is a block diagram of an electronic device with a locking interface.

FIG. 2 is a block flow diagram of a locking process implemented in an electronic device.

FIG. 3 is a logic algorithm for locking an electronic device according to a first embodiment.

FIG. 4 is logic algorithm for locking an electronic device according to a second embodiment.

### DETAILED DESCRIPTION

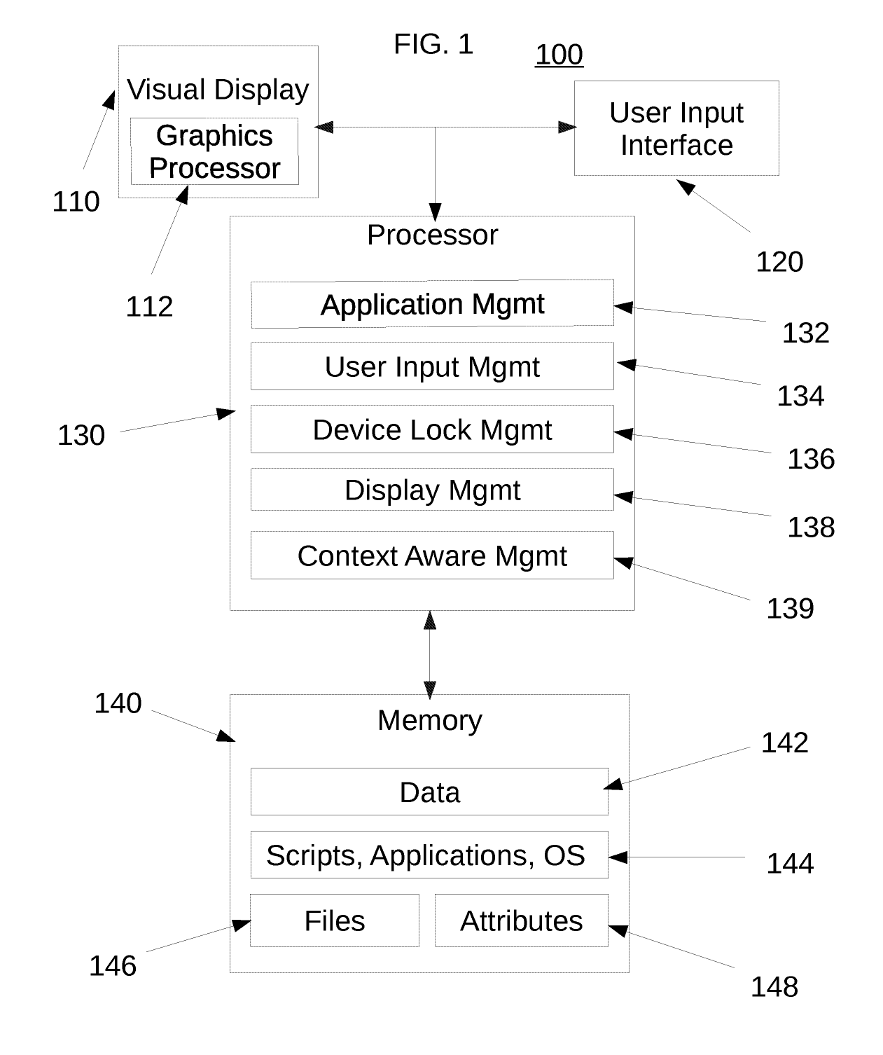

FIG. 1 is a schematic illustration of an electronic device 100 embodied as a hand-held device, tablet, remote control device, notebook or laptop computer, gaming device, inventory scanning device, navigation device, or some other hand-held or portable electronic device. In some embodiments, the electronic device is implemented as a cellphone or other wireless device configured for voice or data communications over a wireless interface like LTE, UMTS, WIFI, and Bluetooth among other known and future interfaces. In other embodiments, the teachings herein are implemented in a desktop computer having separate or discrete components, like a case for a processor, memory and disk drive, and a separate keyboard and monitor. The overall architecture of these electronic devices is known generally by those of ordinary skill and is not described further except as necessary to make and use the teachings disclosed herein.

In FIG. 1, the electronic device 100 generally comprises a visual display interface 110, a user input interface 120, a digital processor 130, and memory 140, which may store processor-executable code. The processor is configured to perform various functions described herein upon execution of the processor-executable code stored in memory. Alternatively, these functions may be performed by equivalent hardware circuits or by a combination of hardware and software. The processing and related circuits and equivalents thereof are referred to herein generally as electrical circuits. While the functions 132, 134, 136, 138 and 139 of the processor are shown and described separately, they may be implemented by a common algorithm that constitutes a part of, or communicates with, an operating system like Android, iOS, Windows Mobile, Tizen, Blackberry, Firefox, Ubuntu Touch among many others. In other implementations, equivalent analog circuits perform all or a portion of the functionality implemented by the execution of programmed instructions.

The visual display interface 110 may be implemented using any suitable display technology. Currently favored technologies include, for example, organic light-emitting diode (OLED) and liquid crystal (LC) technologies. Electroluminescent (EL) and gas plasma displays, among other existing and future technologies may also be used. These and other technologies may be supplanted by later developed technologies. In one embodiment, the display interface is an integral part of the portable electronic device. More generally however the display interface may be a discrete portable component that is separate from a host device. The processing and rendering of images on the visual display interface is performed by a general purpose or a special purpose image or graphics processor that may be programmed with executable code and may include acceleration hardware. In FIG. 1, the visual display interface 110 includes a graphics processor 112, which processes display data and renders corresponding images. Alternatively, some or all of the image processing and rendering functionality may be implemented by display management functionality 138 implemented by the processor 130. Other aspects of the display management functionality are discussed further below. The particular form of the visual display interface is not particularly relevant to the disclosure except that it must display images in response to inputs or other prompts as described more fully herein.

The user input interface 120 may be implemented as any user input interface integrated with the electronic device or coupled thereto as an accessory. In one embodiment, the user input interface is one or more keys. The one or more keys may be physical stand-alone keys or one or more keys that are part of a keypad or a keyboard with any known or future form factor or layout. The one or more keys may also be implemented as one or more virtual keys on a touch interface. In FIG. 1, for example, a virtual key pad may be implemented on the visual display device 110. Thus the user input interface 120 in FIG. 1 is also representative of a touch interface disposed on or integrated with the visual display interface 110 or other components of the electronic device, some of which are discussed below. The user input interface may also be implemented using other user input technologies, like a pointer, track ball, gesture recognition, voice recognition, image recognition (e.g., arterial, retina, iris, facial, etc.), fingerprint detection, among other known and future input detection technologies. Combinations of any of these and other input devices or technologies may also be used. The particular form of the user input interface is not particularly relevant to the disclosure except that the device must recognize an input for the purposes described more fully herein. Such recognition may be accomplished readily by configuring or programming a processor of the device to associate specified inputs with specified functionality or by equivalent hardware circuits or a by combination thereof.

Any processing required by the user input interface may be performed in whole or in part by a dedicated processor, a general purpose processor, or equivalent electrical circuits. In FIG. 1, for example, the processor 130 implements user input management functionality 134, upon execution of code stored in memory, to process inputs received by the user input interface 120. Alternatively, this functionality may be implemented by equivalent hardware circuits or a combination of hardware and software. In some implementations, the user input interface includes a local processor or other device for processing or conditioning inputs received before communication with the processor. The user input interface may communicate with the processor using a propriety or standard communication format or protocol. According to one aspect of the disclosure, the central processor or other processor communicates with other components (e.g., the visual display interface) of the device or other devices in response to inputs at the user input interface as discussed herein.

In some embodiments, the electronic device defaults to a locked configuration wherein the device is unresponsive to user input until proper authentication is received. For example, when a locked device is powered ON, an authentication prompt may be displayed on the visual display interface. Some devices with a default lock mode are configured to lock automatically after some specified period during which no user activity is detected. Also, such devices may enter a sleep or low power mode when locked after the time-out period. In some embodiments, the visual display interface is partially or fully deactivated (e.g., dimmed or turned OFF) when the device enters one of these modes. A locked device in a sleep or low power mode may display the authentication prompt upon being awakened, for example, in response to a touch or swipe or other input at the user input interface. Alternatively, authentication information may be input at a user input interface, like a keypad or fingerprint detector, without first activating the display or displaying a prompt. Thus in electronic devices that lock by default, the processor is configured, upon execution of the processor-executable code, to unlock the device in response to authentication received at the user input interface. In some devices, the processor may display a home screen image on the visual display interface upon being powered ON. If the device is locked by default, the device may be unresponsive to user inputs until authentication information is input to the device. However some locked devices provide limited functionality when the device is locked. For example, wireless communications devices in some countries must be capable of making emergency calls (e.g., E-911) calls when locked. In other embodiments, the electronic device does not default to a locked configuration and thus the device is responsive to user input without prior authentication. In some implementations, specific applications or features may require authentication before running or before providing user access to these applications or features regardless of whether the device has a default lock mode. Thus in some devices, multiple levels of authentication may be required.

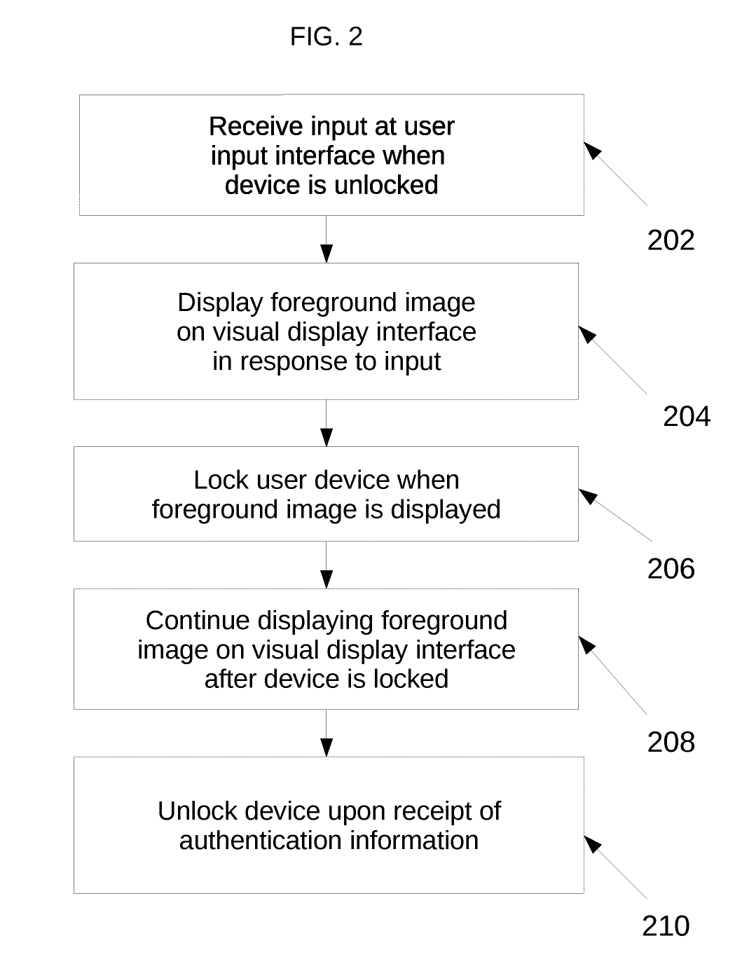

In FIG. 2 at 202, according to one embodiment, the electronic device receives an input at the user input interface and the input is recognized by the electronic device as a prompt to display a foreground image as discussed herein. In FIG. 1 the input is received at the user input interface 120. The input could be the selection of an icon, an executable file, a uniform resource indicator (URI) (e.g., an HTTP or FTP link) or other internal or external link to content. Such selection could be via an interactive touch interface, a pointing device or the selection or activation of a programmable or dedicated hard or soft input key. Alternatively, the selection could be by a voice command or a gesture command or some other input to the electronic device that is detectable and recognizable as such by the device. Thus the selected content may or may not necessarily be displayed on the visual display interface before selection. Any one of these or other inputs can be recognized as a request or command to display a selected foreground image, either through programmed instructions executed by the processor or by equivalent hardware circuits or by a combination of hardware and software. In FIG. 1, the processor implements user input management functionality 134 that recognizes a particular input received at the user input interface as prompting the display of a selected or implicated foreground image and initiates the display of the foreground image on the visual display interface.

In FIG. 2 at 204, a foreground image is displayed on the visual display interface in response to the input received at the user input interface. In one embodiment, the electronic device is programmed with executable instructions that configure the processor to recognize the input at the user input interface as prompting the display of a selected foreground image and to initiate the display of the selected or implicated foreground image. In FIG. 1, the processor implements display management functionality 138 that causes the rendering or display of the selected or implicated foreground image on the visual display interface in response to the input at the user input interface. Alternatively, this functionality may be performed by equivalent hardware circuits or by a combination of hardware and software. In devices that include a home screen displayed on the visual display interface, the displayed foreground image is different than the home screen.

In FIG. 1, the foreground image is obtained or derived from information or content stored in whole or in part on the device or on a remote server communicably coupled to the device, or based on a combination of local and remote content. In FIG. 1, such content is embodied as any one of data 142, applications 144, and files 146 or other information stored in memory 140. Alternatively, the content could be stored in whole or in part on a remote server or in a cloud based server that is accessed by a wired or wireless modem. Communication protocols enabling two-way communications between the device and a remote repository are known generally. In such embodiments, content obtained from the remote source may be buffered at least temporarily on the device prior to or during display if not stored permanently on the device.

The foreground image displayed on the visual display interface is representative of any content. The foreground image could be a visual realization of a data file or streaming content. In one embodiment, the foreground image is obtained from an image file stored locally or remotely. Such image files may be formatted as JPEG, GIF, TIFF, BMP, PNG, WebP, among any other known or future file formats. The foreground image could also be an instantiation of some other file like a document or a web page file. Such document files may be formatted as PDF, ODT, HTML, DOC, GDOC, ODF, among any other known or future file formats. In other embodiments, the foreground image is video content obtained from a video file stored on the device or streamed to the electronic device from a remote location. In some applications, the device may also output audio content associated with video content displayed as a foreground image. Such audio-video content may be formatted as 3GP, MP4, AVI, Matroska Multimedia Container (MMC), Advanced Systems Format (ASF) among any other known or future video file formats. In still other embodiments, the foreground image is an instantiation of an application running on the electronic device. The application may be local or server based. Such applications include, but are not limited to, office productivity applications (e.g., word processing, spreadsheet, presentation, graphics, etc.), games, email, browsers, among many others. The displayed foreground image may also be a combination of these and other types of content.

According to another aspect of the disclosure, illustrated at 206 in FIG. 2, the device is locked when the foreground image is displayed on the visual display interface. Generally, the device may be locked upon displaying the foreground image or after the foreground image is displayed, depending on the mechanism by which the device is locked as discussed further herein. In FIG. 1, the processor implements display management functionality 136, upon execution of processor executable instructions stored in memory, to lock the device automatically or in response to one or more locking commands manually input by the user. According to this aspect of the disclosure, the electronic device is locked when the foreground image is displayed whether or not the device is configured to lock by default (e.g., upon power-up or upon expiration of a time-out period). In devices having a home screen, the device may be locked upon displaying a foreground image other than the home screen.

The effect of locking the device upon displaying a foreground image is not the same as a default lock mode that occurs when the device is powered ON or when the device locks upon time-out of a sleep mode timer. A device locked by default upon power ON or upon time-out of a sleep mode timer displays a default image on the visual display interface and the device is inaccessible until authentication information is input to the device, subject to certain possible exceptions. Such a default locked device image may be a locked home screen, an authentication prompt, or some other default image configurable by a user in a set up mode. When the default locked device image is displayed, the locked device will not permit access to any information on the device other than an authentication interface until authentication information is input to the device. In FIG. 2, at 206, the device may be locked when a foreground image other than a default locked device image is displayed. Further, a device locked when the foreground image is displayed continues to display the foreground image and may provide the user access to features and functions of the device associated with the foreground image. But the locked device is substantially unresponsive to input at the user input interface for other purposes when the foreground image is displayed. Thus in some embodiments the locked electronic device does not respond to any inputs or implement any commands received at the user input interface until unlocked. And in other embodiments, the locked device responds to a limited set of commands associated with the foreground image until unlocked.

Generally, a locked device displaying a foreground image may be unlocked by inputting an unlock command at the user input interface. The unlock command may be a specified input, for example, a particular key stroke or sequence or series of keystrokes, swipes, or other commands (e.g., voice commands). In some embodiments, authentication is required to unlock the device displaying the foreground image. For example, the device may be unlocked upon inputting authentication information at an authentication interface of the device. Generally, in embodiments where the device has a default lock mode, authentication is required to unlock the locked device displaying a foreground image. But such authentication may be required whether or not the device has a default lock mode. The unlock command may be specified at a user configuration or setup interface. Whether authentication is required to unlock the device may depend on the purpose for locking the device. Authentication may be required where the device is locked to prevent untrusted third party access to the device. However authentication may not be required where the purpose for locking the device is to prevent inadvertent closing or minimizing of the application that may occur during handling of the device. The use of a simple unlock command that permits the user to readily unlock the device may be preferred over inputting an authentication passcode.

Generally, a locked device prevents using features and functions of the device (e.g., communications) or from accessing information on the device (e.g., applications, content, etc.) other than the information displayed as foreground image without first unlocking the device. Some electronic devices however provide limited functionality unrelated to the displayed foreground image when locked. For example, laws or regulations in some jurisdictions require that certain communication devices permit emergency (e.g., E-911) calls when locked. There may be other circumstances where limited access is provided to the device when the device is locked.

In FIG. 2, at 208, the foreground image remains displayed on the visual display interface after the device is locked. According to this aspect of the disclosure, no other information may be displayed and access to the device is otherwise prohibited until and unless proper authentication information is received by the device as illustrated at 210, subject to limited exceptions described herein. Thus in some embodiments a locked hand held electronic device displaying a foreground image will not permit access to other content on the device or permit removing the foreground image from the visual display interface by inadvertent or intentional effort. As suggested, the device may be unlocked upon receipt of an unlock command like authentication information when the foreground image is displayed. For example, a locked device may be prompted to display an authentication input interface upon receipt of a specified input. Such an input may be made input using a specific key, which may be configured using a programmable interface of the device. Alternatively, the authentication information may be input without displaying an authentication prompt. For example, biometric data like a fingerprint may be provided at a fingerprint reader of the device or a voice command may be input to a microphone of the device without first displaying an authentication interface on the visual display device. In other embodiments however the device may be unlocked without authentication information.

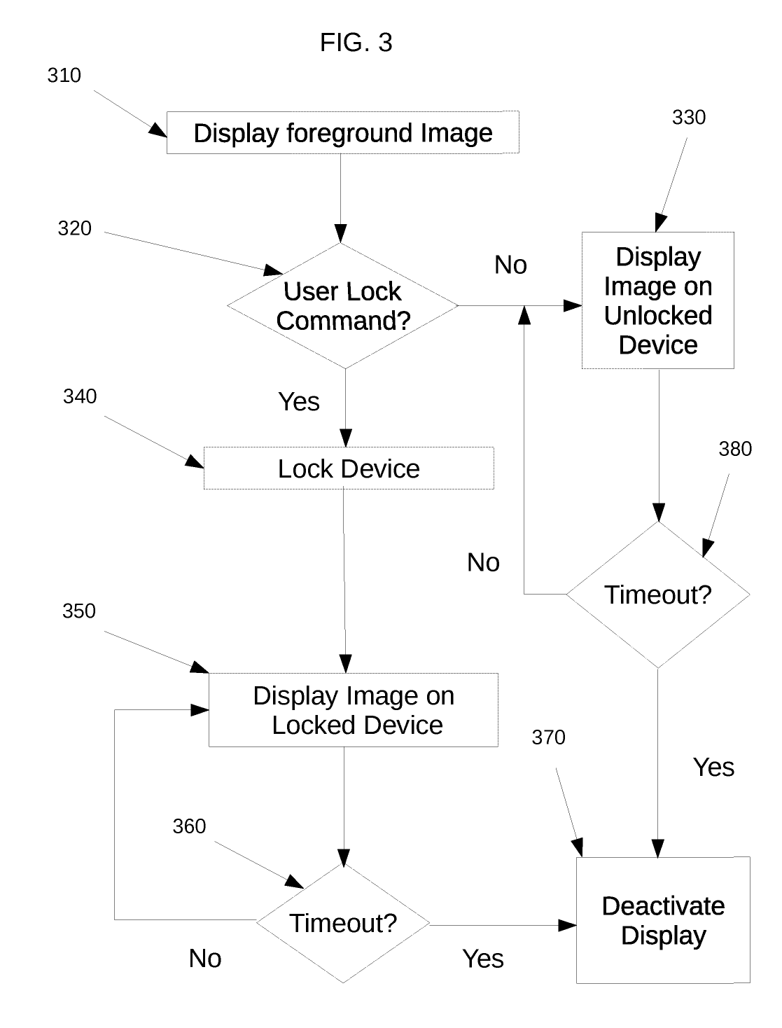

In one embodiment, illustrated in FIG. 3, the electrical device is locked manually by the user after the foreground image is displayed. According to this embodiment, at 310, the foreground image is displayed while the device is unlocked. At 320, the device monitors the user input for a lock command. At 330, in the absence of a lock command, the device remains unlocked and the foreground image remains displayed on the visual display interface. At 340, in the presence of a lock command, the device is locked and at 350 the foreground image remains displayed on the locked device. The input that prompts the locking of the device could be any input. Such input could be preprogrammed or configured or programmed by the user at a user configuration interface. For example, the user may program the device so that an input from a particular key or key combination locks the device. A touch interactive device could be programmed to interpret a voice command, a swipe pattern, or one or more taps or key actuations for this purpose. The device could also be programmed to require authentication to effect the lock. Such programming could be performed via a user setup menu, an application that runs on the device, or using some other programmable code.

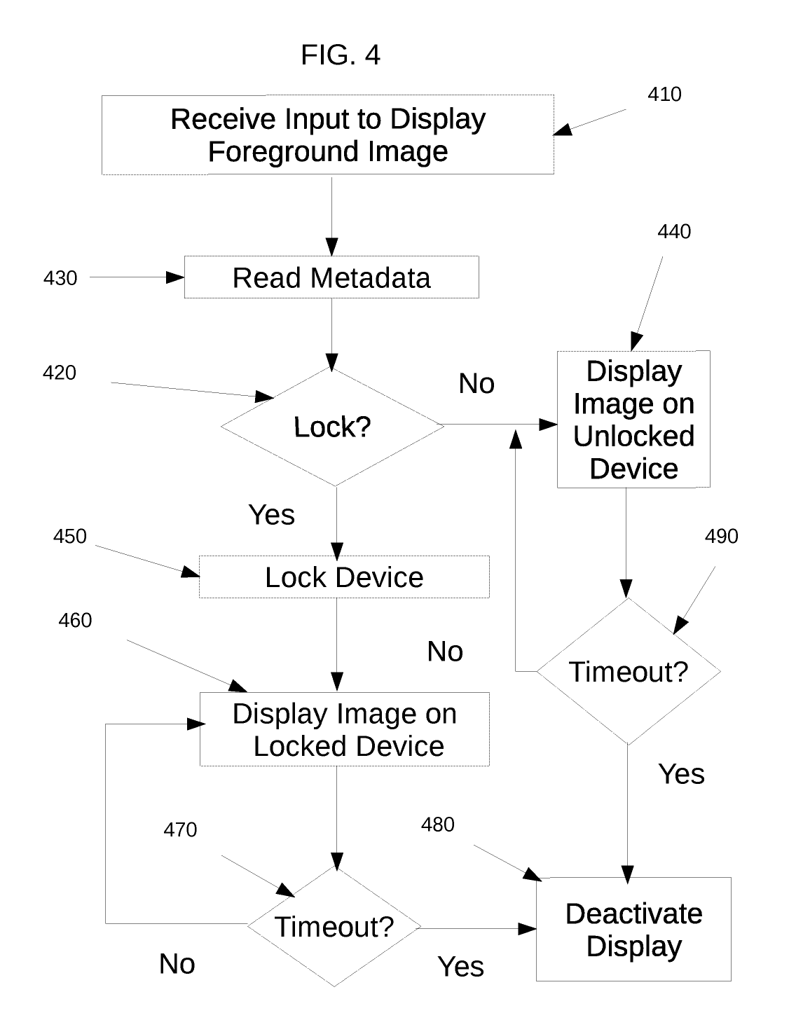

In another embodiment, illustrated in FIG. 4, the user input interface is locked automatically upon selecting or launching the content that constitutes the foreground image. According to this embodiment, at 410, the device receives an input to display a foreground image. At 420, the device determines whether the device should be locked upon displaying the foreground image. At 430, such a determination could be made based on a reading of a lock attribute or metadata associated with the selected content. At 440, in the absence of determining that the device should be locked upon displaying the foreground image, the device remains unlocked and the foreground image is displayed on the unlocked device. At 450, the device is automatically locked upon determining that the device should be locked and at 460 and the foreground image remains displayed on the locked device. The timing of the locking of the device at 420 and the display of the foreground image at 450 shown in FIG. 4 may be reversed. Regardless of the order, the device is automatically locked without further input by the user and the device will not act on commands any input commands before locking the device.

In one embodiment the content constituting the foreground image may have an associated attribute that is interpreted as a command or prompt to lock the device when the content is displayed. The lock attribute may be implemented as code or meta-data used by a script, an application, a web page or browser, an operating system, or some other program to lock the device when the content is selected for display as a foreground image. In one implementation, the code or meta-data is stored in memory of the device in association with content stored locally or remotely. The attribute is interpreted as an instruction to lock the device when the selected content is selected or displayed as a foreground image. As suggested, interpretation of the attribute could be performed by a program (e.g., codec, application, other code, etc.) associated with the selected content and the program could invoke the locking functionality of the device. For example, a web browser may include a script or code that associates a lock command with a specific URI. Thus when the device navigates to the URI with a browser having a lock attribute associated with the URI, the device may be locked automatically upon displaying content at the URI. Alternatively, the device may be locked manually as discussed herein.

FIG. 1 schematically illustrates scripts, applications, one or more operating systems or other programs 144 and attributes 148 stored in memory 140. Generally, the lock attribute may be part of the content file or a separate file associated with the content. While the attributes 148 are shown schematically in a separate block, the attributes may be stored as part of the associated content. Alternatively, some or all of the programs, content and attributes are stored remotely. The attribute may be stored with or without the associated content at a remote server. In another implementation, the attribute associated with content is stored as part of an application, browser, script, or other code or program used to access the content. In other implementations, the attributes are part of a DRM system. In a DRM system, content rights (e.g., access, display, reproduction and other rights) are granted to an authorized user by a DRM manager entity, which may reside on the device or on a remote (distributed) rights management server or entity. The lock attribute may be associated with a display right or it may be a distinct right managed by the DRM system.

In one embodiment, the device includes an application that enables the user to selectively associate a lock attribute to content wherein the attribute prompts or enables locking the device when the content is displayed as a foreground image. Thus the user may selectively tag content with a locking attribute. In other implementations, a creator or issuer of the content may associated the locking attribute with or to the content. Some locking attributes may be permanent or unalterable by the user, for example, where the lock attribute is assigned by the content creator.

In another implementation, the content type may cause the device to be locked upon display of the corresponding foreground image. The content type could be indicated by a file extension of the content wherein opening the file causes or prompts the device to be locked. The file extension could be a new extension, for example, *.lck or some other extension. The content file may be associated with an application or with some other program or code necessary to display the content as a foreground image wherein the program or code also causes the device to lock upon display of the content. According to this embodiment, the device is locked when any file with the specified extension is selected for display as a foreground image on the visual display interface. Thus in some embodiments the file type, rather than a lock attribute or meta-data associated with the file, prompts the device to lock. Alternatively, the particular application, codec or other software used to open or run the file or content may prompt the device to lock upon displaying the foreground image. For example, any content or file launched using a particular application may cause the device to lock. In another implementation, the source of the file or content may prompt the device to lock upon displaying the foreground image. For example, content obtained from a particular folder, URI, third party server or other source may prompt locking of the device.

In some embodiments, the locked device deactivates the visual display interface displaying the foreground image upon expiration of a locked-device time-out period. The locked-device time-out period may be implemented by a timer of the electrical circuit. Generally, the locked-device time-out period may be specific to a particular type of content or it may be a default time-out period applicable to all content displayed as a foreground image when the device is locked. Such a deactivation may be for the purpose of reducing power consumption or limiting the duration that the foreground image is displayed on the visual display interface and thus the time that a third party may view the image. In FIG. 3, at 360, upon expiration of a locked-device time-out period the display is deactivated at 370. Similarly in FIG. 4, at 470, upon expiration of a locked-device time-out period the display is deactivated at 480. In some embodiments, the display is deactivated without closing the application or file associated with the displayed foreground image. In some instances, the device also transitions to a low power mode upon expiration of the locked-device time-out period.

The locked-device time-out period is generally different than a sleep mode time-out period used to lock the device for example in the absence of activity on the device. In FIG. 3, at 370, the display is deactivated upon expiration of a sleep mode time-out period at 380. In FIG. 4, at 480, the display is deactivated upon expiration of a sleep mode time-out period at 490. Expiration of the sleep mode time-out period may also prompt the device to transition to a low power mode. In some embodiments, the locked-device time-out period has priority when the device is locked and the sleep mode time-out period has priority when the device is unlocked. For example, if the locked-device time-out period is greater than the sleep mode time-out period, the locked-device time-out period will govern when the device is locked. In this case, the sleep mode timer may be suspended until the device is unlocked. The suspension may be necessary to ensure that the foreground image is displayed for an adequate duration before the visual display interface is deactivated, particularly where the sleep mode time-out period is relatively short. Generally, both time-out periods may have default settings and both time-out periods may be configured by the user. The sleep mode timer may be set in or from a user configuration interface of the operating system or other program. The locked-device time-out period may be set in or from an application or program that manages the locking of the device.

In some embodiments, when the device is locked, the file or program associated with the displayed foreground image is closed upon expiration of the locked-device time-out period. In other embodiments, the file or program associated with the displayed foreground image continues to run while the display is deactivated upon expiration of the locked-device time-out period. In some embodiments, the deactivated visual display interface of the locked device may be reactivated while the device remains locked without unlocking the device (e.g., upon authentication) to re-display the foreground image. Reactivation may be performed by an input received at the user input interface, wherein the foreground image is redisplayed on the locked device without inputting an unlock command. Such reactivation may also reset the locked-device time-out timer. In this case, the device may be configured to interpret a particular input as a prompt to reactivate the display. For example, the device may reactivate the visual display interface in response to any input other than an input reserved to unlock the device or prompt authentication. Thus an untrusted third party, e.g., a customs or law enforcement officer, may reactivate the display upon time-out of the locked device timer to continue viewing the foreground image without gaining broader access to the device. In some embodiments, the device may permit reactivation of the visual display interface, and thus redisplay of the foreground image some specified number of times without providing an unlock command before the device is subsequently locked. In some embodiments, the user may be able to toggle the visual display interface of the locked device between active and deactivated states without inputting an unlock command. An authorized user may enable the ability to reactivate the visual display interface, set the number of times such reactivation may occur, and specify the reactivation input from a user setup interface.

In some use cases, an authorized user of the electronic device may want to view or share a displayed foreground image embodied as a still image while the device is locked. In this case, the still image is displayed on the visual display interface when the device is locked. The locked device may be handled, by an authorized user or an untrusted third party without permitting more general access to other information on the device or use of the device for another purpose. The locked device may also prevent an inadvertent change in what's displayed on the visual display interface, for example, by preventing minimizing the foreground image or closing an application used to launch and display the foreground image. In some implementations however the locked device may permit limited access to some features (e.g., 911 calling on wireless communication devices) unrelated to the foreground image. When the visual display interface is deactivated upon expiration of the locked-device time-out period, the visual display interface may be reactivated by providing an input to the locked device without authentication as discussed herein. Thus a third party may reactivate the locked device, upon expiration of the locked-device time-out period, without providing authentication information. In some embodiments, the visual display interface of the locked device may be toggled, without authentication, between active and deactivated states upon providing a specified input at the user input interface. The device may be unlocked by providing authentication information as discussed herein.

The foreground image may be a government issued electronic document, like a drivers license, a passport, a visa or some other official document in electronic form. The locked device displaying the foreground image may thus be handled by a government official for the purpose of viewing the image without permitting access to other information or other functions of the locked device. The locked device may also prevent changing what's displayed on the visual display interface. For example, the locked device may be handled by a police officer at a traffic stop, a customs official at a border checkpoint, or other person to view or inspect a government issued document displayed as the foreground image without gaining access to other information or features of the locked device. In other embodiments, the displayed foreground image may be a non-governmental electronic document. Such non-governmental electronic documents include still photographs, proofs of insurance, receipts, transportation boarding passes, parking passes, employee badges, security cards, medical benefits cards, membership cards, credit cards, and other information. Capturing information from these and other documents eliminates the need to carry a hard copy of the document, at least for circumstances where an original document is not required. Advances in digital security and authentication will lead to the eventual elimination of the need for hard copies of many of these and other documents.

The locked device displaying the foreground image may thus be handled, either by an authorized user or an untrusted third party, without permitting access to other information on the device and without inadvertently changing what's displayed on the visual display interface. For example, an electronic aircraft boarding pass may be displayed as the foreground image on the locked device in preparation for presentation of the foreground image to airport security or for scanning of the pass at an aircraft boarding gate without concern for inadvertent closure or minimization of the foreground image while handling the device before presentation for inspection or scanning. Device with touch interfaces are particularly susceptible to inadvertent closing, minimizing or otherwise changing what's display on the visual display interface of an unlocked device.

In some embodiments generally the locked device may also permit access to other features of the locked device that affect or are related to the displayed foreground image. For example, in implementations where the selected content to be displayed as a foreground image cannot be displayed in its entirety on the visual display interface, the locked device may permit the user to view multiple images or pages of the image without authentication. Such viewing may be performed by scrolling or selecting pages by swiping or key activations at the user input interface. The locked device may also permit use of other functions or features associated with the displayed foreground image without authentication. For example, the device may permit changing the size of the image (e.g., zooming) to facilitate inspection of the displayed foreground image without authentication.

In some use cases, an authorized user of the electronic device may want to lock the device during payback of video content displayed as the foreground image. In this case, the video is played on the visual display interface when the device is locked. Audio content associated with the displayed video may also be played on an audio output of the locked device. In some embodiments the locked device may permit access to features of the locked device that affect the displayed video content and related audio content without authentication. For example, the locked device may permit a user to control certain features (e.g., audio control, equalization, pause, stop start, rewind, fast forward, etc.) of the device or application playing the video. Thus generally, the device is locked except for functions that control or enable the playback of the video and related audio content. In other implementations, some or all of these and other device controls may require authentication. As discussed, in some embodiments, other features of certain types of devices (e.g., E-911 calling on wireless communications devices) may be accessible or permitted on the locked device without authentication to comply with regulatory requirements. Thus the locked device may be handled, by an authorized user or an untrusted third party, during video playback without changing the displayed foreground image and without permitting access to other information on the device or use of the device for another purpose during video playback. This may be particularly advantageous for electronic devices with a touch interface where mere handling of an unlocked device may result in an inadvertent change in what's displayed on the visual display interface. Such handling may result in the video being turned off or minimized inadvertently. Locking the device during video playback also prohibits unauthorized access to features and functions of the device without authentication.

When the visual display interface is deactivated upon expiration of the locked-device time-out period during video playback, the visual display interface may be reactivated by providing an input to the locked device without authentication as discussed herein. Thus a third party may reactivate the visual display interface of the locked device without providing authentication information. Alternatively, in some embodiments, the locked-device time-out period may be configured to correspond to the duration of the video to avoid interruption by deactivation of the display. For example, the locked-device time-out period may be changed automatically based on meta data associated with the video upon playback of the video. Such a change may be made where the duration of the video is longer than the default locked-device time-out period upon comparing the duration of the video with the duration of the locked-device time-out duration. In such embodiments, the locked-device time-out period may revert to the default or previous locked-device time-out duration value upon completion of the video playback. The device may be unlocked by providing authentication as discussed herein.

In some use cases, it may be desirable to lock the electronic device when an application is running on the device. Examples of applications for which it may be desirable to lock the device when the application is running include route guidance or navigation applications, game applications, video chat applications, among others. In this case, the displayed foreground image may be the application or a user interface of the application running on the locked device. The locked device may be handled, by an authorized user or an untrusted third party, without changing the displayed foreground image and without permitting access to other information on the device or use of the device for a purpose unrelated to use of the application. For example, other applications, and features and functions unrelated to the application running on the locked device would not be accessible without authentication. Locking the device may also prevent closing the application or minimizing it such that the application runs in the background without being displayed. This may be advantageous for electronic devices with a touch interface where mere handling of an unlocked device may result in inadvertent closing or minimization of the application or deactivation of the visual display interface. When the visual display interface is deactivated upon expiration of the locked-device time-out period, the visual display interface may be reactivated by providing an input to the locked device without authentication as discussed herein. Thus a third party may reactivate the display of the locked device without providing authentication information. As suggested above in some embodiments, the locked device may be configured to permit spontaneous deactivation and reactivation (i.e., toggling the state) of the visual display interface without authentication.

In some embodiments, features and functions associated with the application running on the locked device may be accessible without authentication. Such features and functions are generally available from a user interface associated with the running application. For example, the user may be able to interact with the application, setup or configure the application, control audio associated with the application, etc. without authentication. In other implementations, some or all of these and other device controls may require authentication. Also, as discussed in some embodiments, other features of some type of devices may be accessible (e.g., E-911 calling on wireless communication devices).

In one application use case, the device is locked when a route guidance application is running. In this case, the foreground image is the route guidance application. Besides limiting access to the device beyond use of the application, locking the electronic device permits handling of the device without inadvertently closing or minimizing the application, for example, when driving. As suggested, in some implementations, some features and functions associated with the application running on the locked device may be accessible without authentication. For example, the locked device may permit inputting origin and destination information without authentication. Alternatively, the device may be locked after inputting such information. The locked device may also permit controlling other features and functions of the route guidance application without authentication. The locked device may permit controlling the audio associated with the application, audio alerts generated by the application, and other features and function of the route guidance application without authentication. Generally, however the locked device prohibits access to the device beyond that related to viewing or using the route guidance application.

In another application use case, device is locked when an interactive game application is running. In this use case, the locked device permits user interaction with the game without authentication. The locked device may also permit controlling other features and functions of the game application without authentication. For example, the locked device may permit controlling audio associated with the application, audio alerts generated by the application, game configuration and setup, and other features of the game without authentication. Other than permitting access to the game application and possibly features and functions related to the game, features and functions unrelated to the game are inaccessible without authentication. Locking the electronic device also permits handling of the device without inadvertently closing or minimizing the game application.

In another use case, the device is locked when running an application associated with user selectable files. Such applications include word processing applications, presentation slide applications, spread sheet applications, image management applications, audio and video player applications, among many others. In this case, the application may be launched before an associated file is opened or upon opening the associated file. In either case, the device is locked when the application is launched, or afterwards, and at least a portion of the foreground image includes a user interface portion of the application. The locking of the device could be prompted by launching the application before any user selected files are opened. In this case, the locked device permits the selection of files associated with the application without authentication. Varying degrees of file access may be granted. At one level, any file associated with the application (e.g., files having a specific extension) may be opened by the application. Alternatively, the locked device may limit access to a particular file, or to all files associated with the application, or to files in a particular folder, or to files on a particular drive or at particular IP address, etc. The degree to which the locked device permits access to such files may be configured by the user.

While the present disclosure and what is presently considered to be the best mode thereof have been described in a manner that establishes possession by the inventors and that enables those of ordinary skill in the art to make and use the same, it will be understood and appreciated that myriad modifications and variations may be made to the exemplary embodiments without departing from the scope and spirit of the disclosure, which is to be limited not by the representative embodiments but by the appended claims and their equivalents.

What is claimed is:

1. A portable hand held electronic device comprising:
a visual display interface;
a user input interface;
an electrical circuit coupled to the visual display interface and to the user input interface, the electrical circuit configured to:
display a foreground image on the visual display interface in response to a first input at the user input interface when the device is unlocked, the foreground image different than a home screen image displayed on the visual display interface,
lock the device, and
continue to display the foreground image after the device is locked,
wherein the locked device is substantially unresponsive to input at the user input interface when the foreground image is displayed.

2. The device of claim 1, wherein the electrical circuit is configured to display a locked device image on the visual display interface when the device is in a default lock mode, wherein the device is unresponsive to input other than authentication information at the user input interface in the default lock mode, the foreground image is different than the locked device image.

3. The device of claim 2, wherein, upon receiving authentication information at the user input interface, the electrical circuit is configured to unlock the device in the default lock mode and display the home screen image on the visual display interface of the unlocked device.

4. The device of claim 1 further comprising a clock having sleep mode time-out duration applicable when the device is unlocked and a locked-device time-out duration applicable when the foreground image is displayed on the visual display interface of the locked device, wherein the electrical circuit is configured to discontinue displaying the foreground image upon expiration of the locked-device time-out duration.

5. The device of claim 4, wherein, after expiration of the locked-device time-out duration, the electrical circuit is configured to redisplay the foreground image on the visual display interface of the locked device and reset the locked-device time-out duration in response to a second input at the user input interface when the device is locked.

6. The device of claim 1, wherein the electrical circuit is configured to lock the device in response to a second input at the user input interface after the foreground image is displayed and display a locked device image on the visual display interface.

7. The device of claim 1, wherein, in response to the first input, the electrical circuit is configured to lock the user input interface, in the absence of further input at the user input interface, based on meta-data associated with the foreground image.

8. The device of claim 1, wherein the foreground image comprises any one of a still image, a video image, an application interface, or a government issued document embodied in an electronic form.

9. A portable hand held communication device comprising:
a visual display interface;
a user input interface;
an electrical circuit coupled to the visual display interface and to the user input interface, the electrical circuit configured to:
launch an application and display a foreground image produced by the application on a visual display interface of the device in response to the first input, the foreground image different than a home screen image displayed when the foreground image is not displayed,
lock the device, and
continue to display the foreground image after the device is locked,
wherein the locked device is substantially unresponsive to input at the user input interface when the foreground image is displayed in the absence of authentication information.

10. The device of claim 9, wherein the electrical circuit is configured to process an input at the user input interface when the foreground image is displayed on the visual display interface of the locked device, wherein the input controls a function of the application running on the device.

11. The device of claim 10, the application is a video application, the foreground image is video content, and the function is either an audio control function or a visual display interface control function of the video application for the video content.

12. The device of claim 10, the application is a navigation application, the foreground image is routing information, and the function is either an audio control function or a visual display interface control function of the navigation application.

13. The device of claim 9 further comprising a clock having sleep mode time-out duration applicable when the device is unlocked and a locked-device time-out duration applicable when the foreground image is displayed on the visual display interface of the locked device, wherein the electrical circuit is configured to discontinue displaying the foreground image upon expiration of the locked-device time-out duration, the sleep-mode time-out duration different than the locked-device time-out duration.

14. The device of claim 13, wherein, after expiration of the locked-device time-out duration, the electrical circuit is configured to redisplay the foreground image on the visual display interface of the locked device and reset the locked-device time-out duration in response to a second input at the user input interface when the device is locked.

15. The device of claim 9, wherein, in response to the first input, the electrical circuit is configured to lock the user input interface, in the absence of further input at the user input interface, based on meta-data associated with the foreground image.

16. The device of claim 15 wherein the foreground image is a government issued electronic document.

17. A mobile hand-held communication device comprising:
a visual display interface;
a user input interface;
a processor coupled to the visual display interface and the user input interface;
memory storing processor-executable code coupled to the processor,
the processor configured, upon execution of the processor-executable code, to:
unlock the device and display a home screen image on the visual display interface upon receipt of authentication information at the user input interface when the device is locked,
display a foreground image on the visual display interface in response to an input received at the user input interface when the device is unlocked, the foreground image different than the home screen image,
lock the device when the foreground image is displayed on the visual display interface, and
continue to display only the foreground image after the device is locked,
wherein, in absence of receipt of user authentication information at the user input interface, the device is substantially unresponsive to input at the user input interface while the foreground image is displayed and the device is locked.

18. The device of claim 17, wherein the processor-executable code includes is an image viewing management application and the foreground image is an image associated with the image viewing management application, wherein the image viewing management application prompts the processor to lock the device in response to the first input at the user input interface.

19. The device of claim 18, wherein the foreground image is a government-issued document embodied in an electronic form.

20. The device of claim 17, wherein the processor is configured, upon execution of the processor-executable code, to display a locked device image on the visual display interface when the device is in a default lock mode, wherein the device is unresponsive to input other than authentication information at the user input interface in the default lock mode, the foreground image is different than the locked device image.
